(19) United States
(12) Patent Application Publication
(10) Pub. No.: US 2004/0069802 A1
(43) Pub. Date: Apr. 15, 2004

(54) Concentrate dispensing apparatus for fluid emitting devices

(76) Inventor: Todd Frankel, Redwood City, CA (US)

Correspondence Address: Otto O. Lee, Intellectual Property Law Group, LLP, Suite 1205, 12 South First St., San Jose, CA, 95113, US

(21) Appl. No.: 10/627,432

(22) Filed: Jul. 25, 2003

Related U.S. Application Data
(60) Provisional application No. 60/399,073, filed on Jul. 25, 2002.

(51) Int. Cl. B67D 5/06; B05B 11/02

(52) U.S. Cl. 222/144.5; 222/631

(57) ABSTRACT

The current embodiment of the present invention is an apparatus for attachment to water or other fluid emitting devices and functions to allow a separate exit for soapy water, or other concentrate-fluid mixture, to drain from the faucet without interfering with the existing, clean water or fluid stream. The embodiment does not use gravity to effect placing the soap in contact with the water but rather uses the Venturi effect or similar effect to draw out of the attached reservoir, soap or other concentrate to combine with the water/fluid from the existing water/fluid stream going through the apparatus and thereby emit the mixture from a separate outlet. This embodiment prevents the main, uncontaminated water/fluid stream from ever coming into contact with the soap or concentrate. This apparatus further attaches to an existing water/fluid emitting device, such as a faucet, and requires no installation into or disruption of existing structures. The apparatus is further easily detachable and reattachable as well as separable and modular.

### CROSS-REFERENCE

This application claims benefit of provisional patent application No. 60/399,073 filed on Jul. 25, 2002 which is hereby incorporated by reference in its entirety.

### BACKGROUND OF THE INVENTION

The present invention relates to an apparatus for attachment to a fluid emitting device. In particular the apparatus is applicable to dispensing of a solution separately from the outlet for dispensing the fluid thereby preventing contamination of the existing fluid flow.

Mixing fluids or other types of additives with water is a need and interest for many people. Liquid soaps or other detergents are combined with water at the sink all the time for purposes of washing dishes and other items at a sink or for hand washing. Normally a bottle or dispenser of dishwashing soap is used to integrate the soap with the running water from a faucet in order to obtain soapy water for washing purposes. However, the task of pouring soap into a sponge every time dishes are washed can be a tedious task especially with a large number of dishes to wash and perhaps people on the go do not have much time to create a sudsy soak for plates and pots. Other situations warrant a sink to function efficiently and minimize the need for the installation of separate soap dispensers to existing sink or wall structures. This need is especially apparent in public restrooms where soap dispensers are sometimes non-existent.

Certain devices that attempt to solve these needs have been able to bring the soap to the water faucet. Some of these devices do not mix the concentrate with the water, for instance, soaps that are pumped out of containers or emitted from a scrubbing brush from a soap attachment. The inconvenience of a separate soap dispenser or soap dish can be a nuisance, messy and inefficient. Furthermore, many devices function to mix soap into the same stream of water emitted from the water faucet, spout, showerhead, or other water emitting device. As a result, residue of the soap remains in the water stream so that users who would then desire clean water would find that the water emitted from the faucet now has a soapy residue. This is a problem for people who need to have fresh, clean, soap free water at a moment's notice. Existing products do not address the need for a way to switch between a clean stream of water and a separate mixture of soapy water.

Placing a bottle of soap at the sink does not match the efficiency of having a mixture of soap and water readily available and requires the extra step of handling a bottle of soap. In addition, bottles of soap can be a nuisance by often falling into the sink and further creating a soapy mess on the sink mantle or on countertops. Installing a separate soap dispenser can be costly or not feasible to certain sink or kitchen designs. Some dispensers are installed completely away from the sink area leaving soapy messes near the dispenser and create a water trail between the dispenser and the sink as a person's wet hand moves from the dispenser to the sink. Furthermore, a bar of soap can frequently and annoyingly fall into the sink or onto the floor and usually requires a soap dish which can also be very messy as well as a nuisance to clean.

In other situations, people may desire to have juice on demand or other flavored drinks on demand without having to physically mix a separate batch of drink in an entirely separate container. By eliminating the need to create a pitcher of drink, refrigerators and counter space can be used efficiently.

### SUMMARY OF THE INVENTION

The ability to have both a mixed solution (of water or fluid with a concentrate) as well as a clean water or fluid flow on demand can be obtained, for example, by an apparatus for separating the exit of clean fluid flow and a concentrate solution according to embodiments of the present invention.

According to an embodiment of the present invention, there is an apparatus attachable to water emitting devices or fluid emitting devices for dispensing a concentrate solution separately from the water or fluid flow. The apparatus comprises a body chamber which further comprises a first outlet and diverter valve; a reservoir; an exit tube having a second outlet; and a means for attaching the apparatus to a water emitting device, wherein the concentrate solution is produced by drawing a concentrate fluid from the reservoir to mix with water diverted by the diverter valve when engaged. The concentrate solution exits from the second outlet and never contaminates the normal water flow exiting from the first outlet. The apparatus is attachable to any water emitting device through any means for attachment like a faucet coupler having an “O” ring and retainer ring for the faucet coupler. The reservoir may hold an inlet tube through which the concentrated fluid is drawn out via the venturi effect into the body chamber or other pathway of the apparatus to produce the concentrate solution.

Another feature of the present invention allows for the reservoir to be refilled with concentrated fluid through an opening where the opening is sealable with a removable cap. The reservoir in another embodiment may also be a modular element or may be a disposable element.

In other embodiments of the present invention the apparatus may further comprise a plurality of separate diverter valves in or around the body chamber; a plurality of exit tubes connected to the body chamber; the reservoir separated into one or more compartments for holding one or more concentrated fluids; and a plurality of outlets connected to the exit tubes; so that different concentrate solutions are dispensed through the plurality of outlets, separate from the first outlet from which normal water flows.

According to another embodiment of the present invention, there is one or more flow adjuster valves in addition to the diverter valve, for adjusting the flow of water and the flow of concentrate solution from the outlets.

It is another object of the present invention to be attachable to water emitting devices such as faucets, hoses, cooler dispensers, pipes, tubes, taps and the like. In addition, in an embodiment of the present invention, the apparatus is attached to a water emitting device having an existing water filtering system.

According to another embodiment of the present invention, the concentrated fluid to be mixed with water to produce a concentrate solution is any desired fluid to be mixed with water. Such possible concentrate fluids may be soaps, shampoos, cleansing fluids, drink concentrates, food concentrates, scented fluids, chemicals, sealants, epoxies, and fertilizers.

In yet another embodiment of the present invention, there is an apparatus for mixing and dispensing concentrate solution on demand separately form a normal fluid flow of a fluid emitting device comprising a diverter valve attachable to a fluid emitting device with an existing outlet, the valve having a button, a spring and an internal aperture; a reservoir having an inlet tube connected to the diverter valve; an exit tube; a second outlet attached to the exit tube; a means to connect the apparatus to the fluid emitting device; and a means to draw concentrate out the inlet tube to be mixed with the fluid; wherein engaging the button engages the diverter valve to allow fluid to enter the internal aperture, concentrate is mixed with the fluid and flows into the exit tube as a concentrate solution. The concentrate solution dispenses from the second outlet, separate from the existing outlet where clean fluid is emitted when the button is no longer engaged. Optionally, the button may have a lock to continuously engage the diverter valve. The exit tube may also be modular and attachable to the diverter valve or it may be constructed with the diverter valve as a single combined unit.

It is an object of the present invention that the apparatus may use a venturi effect for drawing concentrate out of the inlet tube of the reservoir. Fluid is forced through the internal aperture and passes the opening of the inlet tube thereby drawing concentrate out of the reservoir, mixing it with the fluid to result in concentrate solution entering the exit tube and out from the second outlet.

It is another object of the present invention that the fluid in the fluid emitting devices is any desired fluid to be mixed with a concentrate to result in a concentrate solution. Such fluids may be water, alcohol, sodas, juices, liquor and other fluids.

In yet another embodiment of the present invention, there is an apparatus for separately dispensing a fluid and one or more concentrate solutions, attachable and detachable to a fluid emitting device comprising a reservoir which can hold more than one concentrate in separate compartments; a body chamber attached to the fluid emitting device and connected to the reservoir having a first outlet and a diverter valve; one or more exit tubes having at least a second outlet for emitting concentrate solutions; and a means for attaching the apparatus to a fluid emitting device; wherein one or more concentrate solutions is produced when concentrates are drawn from the reservoir to mix with the fluid diverted form the fluid emitting device through the diverter valve when engaged, and exits from the one or more exit tubes, never contaminating the fluid flow from the first outlet.

These and other embodiments of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1A is perspective view of the apparatus in a disassembled state according to an embodiment of the present invention.

FIG. 1B is a perspective view showing the apparatus in an assembled state according to an embodiment of the present invention.

FIG. 2A is a left side elevational view cross section of the apparatus, with the cut through the center of the inlet tube corresponding to the inlet point of the apparatus according to the embodiment of the invention

FIG. 2B is a left side elevational view cross section of the apparatus, with the cut through the center of the body of the apparatus according to the embodiment of the present invention.

FIG. 2C is a left side elevational view of the assembled apparatus as shown in FIG. 1B.

FIG. 3A is a front elevational view showing a cross section of the apparatus, with the cut through the center of the exit tube and body of the apparatus according to the embodiment of the present invention.

FIG. 3B is a front elevational view of the assembled apparatus as shown in FIG. 1B according to the embodiment of the present invention.

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

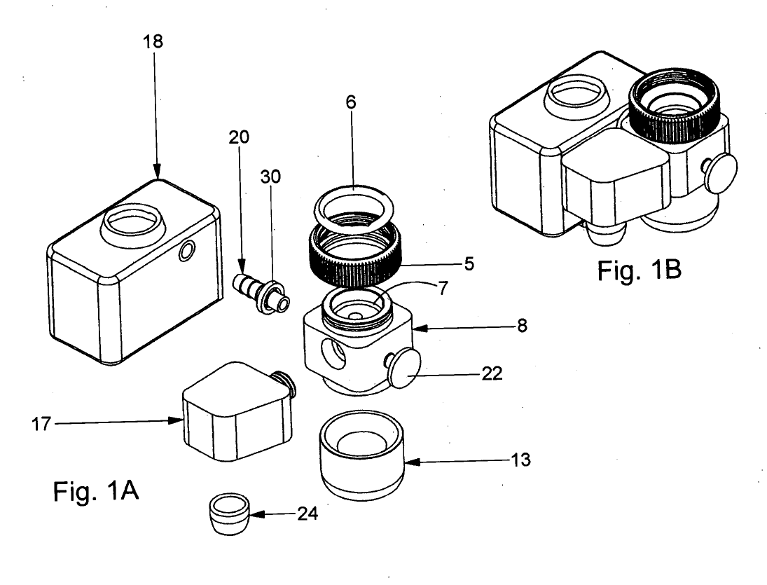

In one embodiment of the present invention, an apparatus dispenses clean water and a separate mixture of water mixed with a concentrated fluid such as liquid soap. As shown in FIG. 1A, a concentrate dispensing apparatus for water emitting devices comprises a reservoir 18 that is joined to a body 8 by a barbed adapter 20. The body 8 is equipped with a plurality of openings to allow for joining of body to other parts of invention. The body 8 is further joined to an exit tube 17 which may be connected to an aerator 24. The exit tube 17 further comprises an outlet to allow mixed concentrate and water to flow out of the apparatus, such as through the aerator 24. The body 8 may be joined to an outside sleeve aerator 13 to add air to the water and regulate flow during normal use. In one embodiment of the present invention, the apparatus may be connected to water emitting devices by means of a faucet coupler 5 and an O ring 6, which fits inside the faucet coupler to allow water-emitting devices to snugly attach to the apparatus without the use of any tools. The user could then connect the apparatus to their existing water emitting device such as a faucet through a standard adapter and corresponding washer. FIG. 1B shows an assembled embodiment of parts as detailed above.

The outlet for the mixed concentrate and water is distinct from the unmixed water outlet, but the two outlets may be either adjacent or in separate locations. After the water and concentrate are mixed together, the mixed fluid may emerge from the apparatus or it may be redirected using a hose or pipe to emerge from another point near the faucet. The number of outlets or nozzles is not limited to two distinct outlets, i.e. the main water faucet and the mixed solution outlet, but rather there could be multiple additional outlets depending on the user's needs.

In other embodiments, the point at which the apparatus is attached to the water-emitting device may vary. Water can be diverted from the faucet through a diverter valve at the tip of the faucet, the faucet neck, the faucet aerator, or at another point along which water flows before reaching the faucet outlet. The apparatus therefore need not include a main body chamber, but can be simply attached to the water emitting device by the diverter valve to divert the water to another point for mixing. The attachment of the apparatus may be either quickly connected to the end of the faucet using one of several standard adapters, and further could be made as a disposable unit or it may be more permanently installed and partially concealed as part of the faucet plumbing.

In another embodiment, the attachment of the apparatus may fit onto a shower head, a shower pipe, or bathtub faucet. The embodiment could therefore be used to mix and dispense shampoo, shower gels, bath oils, liquid soaps, powdered soaps, or bubble bath solution. Alternatively, another embodiment could be used to dispense a shower cleaning substance to remove soap scum, mildew, or fungus. Other embodiments allow for dispensing a perfume, cologne, scented fluids or air freshener.

In yet another embodiment, the attachment may fit onto an office cooler nozzle. Given that office coolers often have separate cold and hot water outlets, the invention could be easily used to mix and dispense hot chocolate, soup, instant coffee, juice, iced tea, or other soft drinks.

In another embodiment, the attachment of the apparatus may fit onto the end of a garden hose. Soap for washing cars, or fertilizers, seeds and other lawn care products may be dispensed through a separate outlet without contaminating the clean water outlet by leaving a residual of concentrate.

In addition, in a further embodiment, the apparatus could be modified to work as a water filtering system or in conjunction with an existing water filtering system. Water filtering could therefore be desired on demand by engaging the apparatus to filter normal water flow.

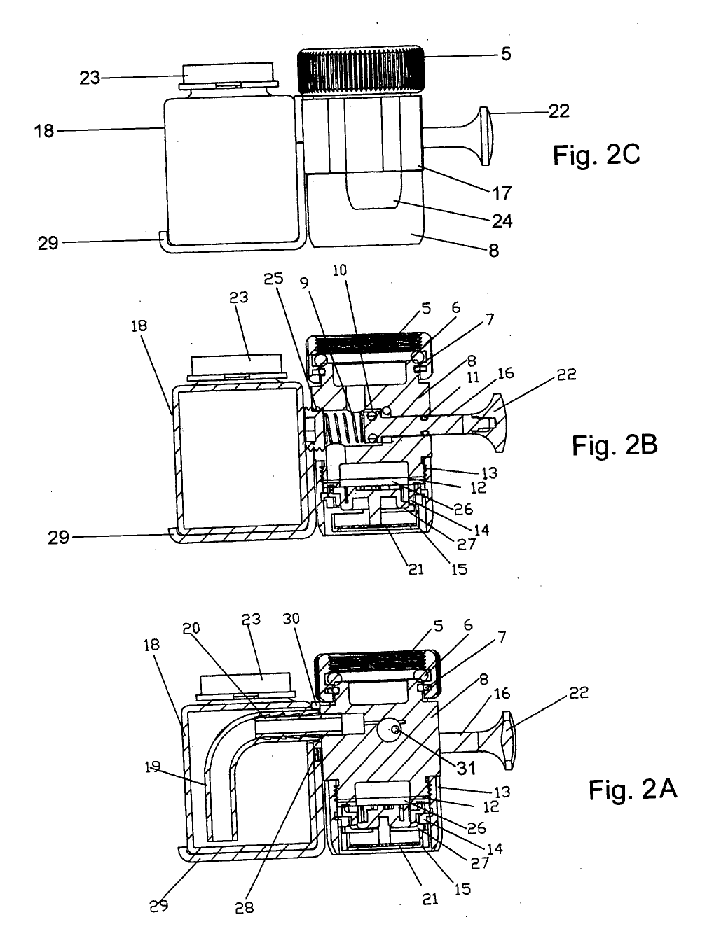

As shown in the embodiment of FIG. 2A, a left side elevational view cross sectional view is shown, with the cut through the center of the inlet tube 19 corresponding to the inlet point of the apparatus according to the embodiment of the invention. As shown, the reservoir 18 houses an inlet tube 19 that connects to a barbed adapter 20, which is then attached to an opening in the body 8 with an inlet tube washer 30, thereby connecting the inlet tube 19 to the body 8. The reservoir 18, body 8 and exit tube 17 are not limited to the shapes depicted in the current embodiment. The reservoir 18, body 8 and exit tube 17 can be a myriad of shapes. The body 8 has an internal opening or aperture 31 which is the inlet point through which water can pass and flow into the exit tube 17. The reservoir 18 may have an opening on the top surface to allow for filling and refilling of concentrate solution that may be fitted with a cap 23. As shown in one of the preferred embodiments, depicted in FIG. 2A, a bracket 29 may be used to firmly attach the reservoir 18 to the body 8 via a set of fasteners such as screws 28.

In addition, the apparatus may be modular, reconfigured and customized for a user's needs. For instance, the reservoir 18 may be remotely attached to the sink for extra storage capacity. The reservoir 18 may also be compartmentalized with multiple compartments with varying contents to have mixed with the water flow or other main fluid flow. As a result, multiple outlets may be drawn from the reservoir 18 to either combine into one separate exit outlet or a plurality of exit outlets, all distinct from the main water/fluid flow. The reservoir 18 can also be made as a disposable unit. In addition, in other embodiments, the apparatus may comprise just the diverter valve 16 connected to the exit tube 17 and reservoir 18, therefore there need not be a main body. The diverter valve 16 and exit tube 17 may be constructed as a single combined unit or as separate attachable elements.

According to FIG. 2B which shows a left side elevational view cross section of the apparatus, the body 8 further contains a valve button 22 that when pushed engages a diverter valve or main shaft 16. The diverter valve 16 may be coupled with two O rings, O ring “a” 10 and O ring “b” 11 along with set screw 25. The diverter valve 16 is located adjacent to a spring 9. When the button 22 is pushed, it engages the diverter valve 16, which acts on the spring 9 and compresses the spring 9. The compression of the spring 9 blocks normal water flow out from the body 8, forcing normal water flow to be diverted and pass through the internal opening or aperture 31 and flow into the exit tube 17. At the same time, when water flows past the internal opening or aperture 31, the concentrate fluid in the reservoir 18 is drawn up through the inlet tube 19 and into the exit tube 17 via the venturi effect. The aperture size can be adjusted using a small needle valve to modify the amount of concentrate that is drawn into the water. The mixed concentrate and water may then exit the apparatus from an opening, a tube or other flow director that is distinct and separate from the outlet for the unmixed water. In one embodiment, the mixed concentrate and water solution exits the exit tube 17 through aerator 24. The body 8 may also contain various aerators, outside sleeve aerator 13, washer aerator 12, diffuser restrictor aerator 26, internal part aerator 14, diffuser aerator 27, screen support aerator 15 and a screen aerator 21, which are designed to control the amount of air in the water during normal flow use. FIG. 2C shows an assembled embodiment of the parts described above.

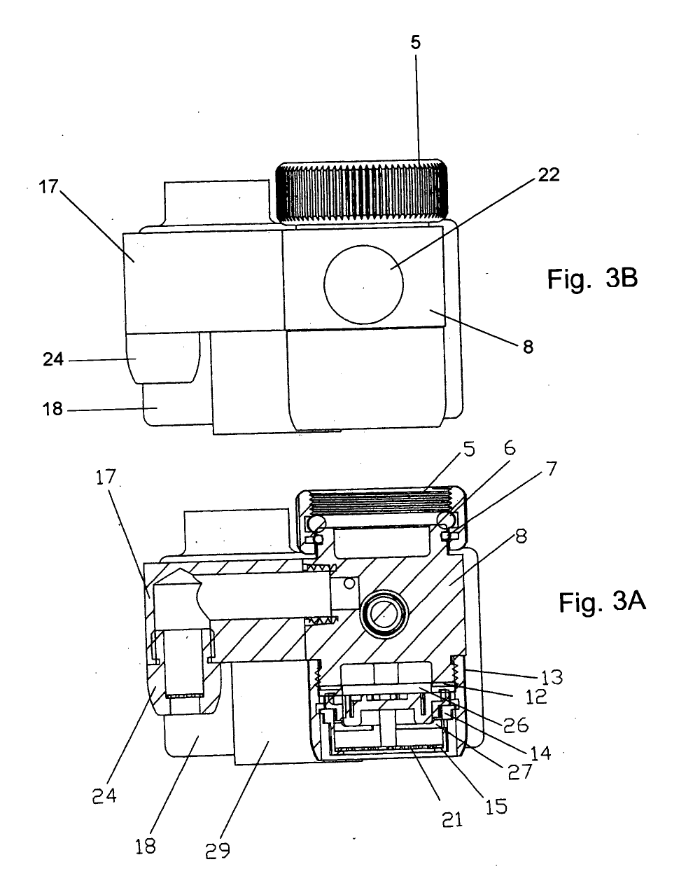

FIG. 3A shows a cross section of a frontal view of the apparatus illustrating parts, which are referenced above. FIG. 3B shows an assembled embodiment of the parts described above.

The diverter valve 16 of the apparatus that diverts the water flow may allow water to flow freely through the faucet, or it may partially or completely divert the water to be mixed with fluid from the reservoir 18. Furthermore, the diverter valve 16 may divert the water for a preset period of time such as when a button 22 is pushed. The diverter valve 16 may therefore be used not only to divert flow to be mixed but also to create intermittent bursts of mixed or unmixed water flow at the pressure and volume set by the faucet controls.

In other embodiments of the present invention, the mixing may occur within a distinct mixing chamber or simply within a water passage or valve. Such a mixing water passage may occur anywhere within the apparatus such as in the reservoir 18. In another embodiment, the internal opening or aperture 31 may be configured at a point near or in the reservoir 18 itself, wherein the diverter valve 16 would force water toward the aperture 31. Therefore, the mixing point need not occur in a body chamber. The concentrate may be drawn out of the reservoir by venturi effect, pushed out of the reservoir, or moved through some other effect or combination of effects. The embodiment therefore not only dispenses soap, but it evenly mixes the soap with the water without the need for the expenditure of time or effort. Also, the mixing occurs without the use of a separate sponge or brush to spread soap on an object. Furthermore, the mixed soap and water solution may exit an outlet that is modifiable by different aerators; in addition the outlet may be replaced by varying spray patterns.

The amount of water and soap that are mixed together may be controlled using valves that are distinct from the diverting valve 16. One such valve may control the total volume flow by partially obstructing the diverted water flow, either before or after the point where soap is mixed into the water. Another valve may be used to control how freely soap enters the mixing area. For example, the second valve may be a needle valve that is positioned over the concentrate entrance aperture 31.

In addition, other control features may be added to the apparatus to regulate the main water flow or meter the amount of concentrate to be mixed with the water. Additional positions may be created on the apparatus to stop the faucet water completely for example a rotary knob may be rotated up to provide soap draw, rotated again may shut off all water and rotated once again may bring it to the start with clean water again. Different levers or plungers may also be incorporated into the apparatus such a push back versus pull forward button 22 which may be lockably engaged or not.

The apparatus can be made of a variety of materials such as plastics, metals, nickel plated brass, stainless steel, nylon, and other materials, in different colors or sizes. The reservoir, body and exit tube can be made of various shapes. In one embodiment of the present invention, an apparatus dispenses clean water and a separate mixture of water mixed with a concentrated fluid such as liquid soap. In another embodiment of the present invention, other concentrated fluids that may be mixed with the water. For instance, drink mixes such as coffee, tea, juice, or punch could be used as the concentrated fluid. Furthermore, the content of the reservoir may be either a concentrated liquid or a powder that will eventually be mixed with a liquid. In addition, soup or soup base may be mixed in with a hot water flow. Also, many soft drink concentrates may be mixed into a cold water flow.

The reservoir holding the concentrate may be part of the attachment, or it be connected to a tube or pipe connected to the attachment. The reservoir may be made of a clear or opaque material, and it may be decorated or undecorated. The reservoir may be any shape. Furthermore, the reservoir may be refillable, disposable or replaceable. Through the use of further valves and modifications, the reservoir could be divided into a number of chambers for different types of fluids. In addition, the apparatus may be adapted to accept more than one reservoir at a time.

Accordingly, since there may be more than one reservoir or a reservoir or many compartments, the apparatus may be customized to allow for multiple orifices of different size, creating different venturi draws on the multiple reservoirs. For instance, a particular soap may be mixed with a scent drawn from separate reservoir compartments. In addition, not only can the reservoir be compartmentalized, but additional containers may be added to enlarge the reservoir bank. Different venturi draws may be connected to these separate containers and provide different amounts of material from each container. The specified venturi draw would determine the mixing ratio and the amount drawn. In the example of beverage mixing, one reservoir component may have a certain fruit juice concentrate, another may have yet a different fruit juice concentrate which may be combined together with water, all at different desired amounts based on the venturi specification.

In another embodiment, air instead of water may be used to mix with concentrates. Other alternative substances besides water may be implemented for mixture with other concentrates, for instance, an alcoholic beverage, an epoxy, an industrial chemical, a sealant, or any other fluid that is commonly mixed with other fluids or mixtures. A restaurant may want to be able to quickly mix drinks and sodas with additives like vanilla or lemon juice. In addition, they may want to mix cream or sugar with coffee at the tap. A bar or catering service may want to be able to mix common drinks such as vodka or rum with other drinks in a way that is quick, efficient, and consistently measured. Furthermore, a manufacturing plant may want to be able to quickly mix chemicals for use on an assembly line without having to use a separate mixing step.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description, but rather is indicated by the appended claims. All changes that come within the meaning and range of equivalents within the claims are intended to be considered as being embraced within the spirit and scope of the claims.

What is claimed is:

1. An apparatus for separately dispensing clean water and a concentrate solution, detachably attached to a water emitting device comprising:
(a) a body chamber attached to the water emitting device, further comprising:
i. a first outlet for exit of a normal water flow;
ii. a diverter valve to divert the water flow from the water emitting device;
(b) a reservoir to hold a concentrated fluid, connected to the body chamber;
(c) an exit tube for releasing mixed water and concentrated fluid which forms the concentrate solution having a second outlet for exit of the concentrate solution; and
(d) a means for attaching the apparatus to a water emitting device;
wherein the concentrate solution is produced by drawing concentrated fluid from the reservoir to mix with water when the diverter valve is engaged and the concentrate solution exits the second outlet, never contaminating the normal water flow which exits from the first outlet.

2. The apparatus according to claim 1 wherein when the diverter valve is not engaged, normal water flow emits from the first outlet and concentrate solution is blocked from exiting the second outlet.

3. The apparatus according to claim 1 wherein the reservoir further comprises an inlet tube through which concentrated fluid is drawn out via the venturi effect into the body chamber of the apparatus to produce the concentrate solution.

4. The apparatus according to claim 1 wherein the means for attaching to a water emitting device is through a faucet coupler, an “O” ring for the faucet coupler and a retainer ring for the faucet coupler.

5. The apparatus according to claim 1 wherein the water emitting device is a faucet, hose, cooler dispenser, pipe, tube, or tap.

6. The apparatus according to claim 1 wherein the reservoir has an opening through which the reservoir is refilled with concentrated fluid, the opening being sealable with a removable cap.

7. The apparatus according to claim 1 wherein the diverter valve comprises a button to engage the diverter valve on demand and the button continuously engages the diverter by an optional lock.

8. The apparatus according to claim 1 further comprising:
(a) a plurality of separate diverter valves in the body chamber;
(b) a plurality of exit tubes connected to the body chamber;
(c) the reservoir separated into one or more compartments for holding one or more concentrated fluids; and
(d) a plurality of outlets emitted from the exit tubes;
wherein different concentrate solutions are dispersed through the plurality of outlets separate from the first outlet for normal water flow.

9. The apparatus according to claim 1 further comprising one or more flow adjuster valves for adjusting the flow of water and the flow of concentrate solution from the first outlet and the second outlet.

10. The apparatus according to claim 1 wherein the water emitting device has an existing water filtering system.

11. The apparatus according to claim 1 wherein the concentrated fluid is any desired fluid to be mixed with water to produce a concentrate solution.

12. The apparatus according to claim 11 wherein the concentrated fluid is soap, shampoo, cleansing fluid, drink concentrate, food concentrate, scented fluid, chemical, sealant, or epoxy.

13. An apparatus for mixing and dispensing concentrate solution on demand separately from a normal fluid flow of a fluid emitting device comprising:
(a) a diverter valve attachable to an existing outlet of the fluid emitting device having;
i. a button attached to a spring that diverts normal fluid when engaged; and
ii. an internal aperture;
(b) a reservoir for holding a concentrate having:
i. an inlet tube connected to the diverter valve via an adaptor;
ii. an opening located on a top side of the reservoir to allow for the concentrate to be dispensed into the reservoir;
iii. a removable cap to seal the opening;
(c) an exit tube attached to the diverter valve or constructed into the diverter valve as a single combined unit;
(d) a second outlet attached to the exit tube wherein the concentrate solution is dispensed from the device;
(e) a means to connect the apparatus to a fluid emitting device; and
(f) a means for drawing the concentrate out the inlet tube and mixing the concentrate with the normal fluid;
wherein by engaging the button forces normal fluid through the internal aperture, concentrate is mixed with the normal fluid and flows into the exit tube as concentrate solution, allowing for dispensing of the concentrate solution on demand through the second outlet and wherein the normal fluid is emitted from the existing outlet when the button is disengaged.

14. The apparatus according claim 13 wherein the means used for drawing concentrate out of the inlet tube is by way of the venturi effect.

15. The apparatus according to claim 13 further comprising one or more flow adjuster valves for adjusting the flow of normal fluid and the flow of concentrate solution from each outlet.

16. An apparatus for separately dispensing a fluid and one or more concentrate solutions, attachable and detachable to a fluid emitting device comprising:
(a) a reservoir to hold one or more concentrates each concentrate in a separate compartment;
(b) a body chamber attached to the fluid emitting device and connected to the reservoir, further comprising:
i. a first outlet for exit of a fluid flow;
ii. a diverter valve to divert the fluid flow from the fluid emitting device; and
(c) one or more exit tubes for receiving one or more concentrate solutions, having at least one second outlet for exit of one or more concentrate solutions;
(d) a means for attaching the apparatus to a fluid emitting device;
wherein the one or more concentrate solutions is produced through the venturi effect of drawing a concentrate from the reservoir to mix with fluid when the diverter valve is engaged whereby the one or more concentrate solutions enter the one or more exit tubes, exits a second outlet and never contaminates the fluid flow from the first outlet.

17. The apparatus according to claim 16 wherein the diverter valve is engaged to allow for an “on” position of normal fluid flow, engaged further to allow for concentrate solution to flow from the second outlet, disengaged to block both fluid flow and concentrate solution from exiting the apparatus in an “off” position.

18. The apparatus according to claim 16 wherein diverted fluid passes by an internal opening of the body chamber creating a vacuum that causes concentrate from the reservoir to draw through an inlet tube from the reservoir via the venturi effect and empty into the attached exit tube.

19. The apparatus according to claim 16 wherein diverted fluid passes by an internal opening in or near the reservoir creating a vacuum that causes concentrate from the reservoir to draw through an inlet tube from the reservoir via the venturi effect and empty into the attached exit tube.

20. The apparatus according to claim 16 further comprising one or more flow adjuster valves for adjusting the flow of fluid and the flow of concentrate solution from each outlet.

21. The apparatus according to claim 16 wherein the reservoir is separable and disposable.
